(19) United States
(12) Patent Application Publication
(10) Pub. No.: US 2025/0117116 A1
(43) Pub. Date: Apr. 10, 2025

(54) SYSTEM AND METHOD FOR INTERACTIVE STORYTELLING: GUESS-THEIR-ADVENTURE FOR PRACTICING PERSPECTIVE TAKING

(71) Applicant: TOYOTA RESEARCH INSTITUTE, INC., Los Altos, CA (US)

(72) Inventors: Matthew Len LEE, Mountain View, CA (US); Francine R. CHEN, Menlo Park, CA (US); Scott CARTER, San Jose, CA (US)

(73) Assignees: TOYOTA RESEARCH INSTITUTE, INC., Los Altos, CA (US); TOYOTA JIDOSHA KABUSHIKI KAISHA, Aichi-ken (JP)

(21) Appl. No.: 18/484,362

(22) Filed: Oct. 10, 2023

(51) Int. Cl. G06F 3/0484; G06F 40/205; G06V 30/19

(52) U.S. Cl. CPC G06F 3/0484; G06F 40/205; G06V 30/19

(57) ABSTRACT

A method for an interactive storytelling system is described. The method includes parsing collected story narratives into a plurality of story narratives linked by story development questions. The method also includes presenting a selected story narrative, including a selected story development question regarding a prediction of a story development in the selected narrative. The method further includes determining a difference between the story development in the selected narrative and an answer received in response to the selected story development question. The method also includes selecting a next, selected story narrative of the story development based on the difference, including a next selected story development question regarding a next prediction of the story development in the next, selected narrative. The method further includes repeating the presenting, the determining, and the selecting based on subsequent differences between the story development in subsequent narratives and subsequent answers received in response to subsequent questions.

### BACKGROUND

### Field

Certain aspects of the present disclosure generally relate to machine assisted cognition and, more particularly, to a system and method for interactive storytelling: guess-their-adventure for practicing perspective taking.

### Background

Story creators may utilize story curation tools to provide an online platform for creating and showcasing their creative work. Storytelling often is a passive activity where the listener just listens to the story. By contrast, interactive storytelling may involve asking participants to engage their perspective taking skills to predict what the person would do next. Studies show that people who interact more with people on the other side of an issue tend to have more empathy towards them or at least can understand why others take their stance. Nevertheless, people often stay in their own bubble and don't have chances to interact regularly with the people different from them.

In particular, other people's lives are thus a mystery, or worse, assumed to be a certain negative, stereotyped, or dehumanized way that further distances the individual from other people. Individuals can certainly read, watch videos, documentaries, or hear stories about other people, but these may not always be engaging nor do people explicitly want to sit down and engage with these media. An engaging way to interact with other people's narratives in a way that helps individuals understand the situation of their lives and build empathy with people different from them, is desired.

### SUMMARY

A method for an interactive storytelling system is described. The method includes parsing collected story narratives into a plurality of story narratives linked by story development questions. The method also includes presenting a selected story narrative, including a selected story development question regarding a prediction of a story development in the selected narrative. The method further includes determining a difference between the story development in the selected narrative and an answer received in response to the selected story development question. The method also includes selecting a next, selected story narrative of the story development based on the difference, including a next selected story development question regarding a next prediction of the story development in the next, selected narrative. The method further includes repeating the presenting, the determining, and the selecting based on subsequent differences between the story development in subsequent narratives and subsequent answers received in response to subsequent questions.

A non-transitory computer-readable medium having program code recorded thereon for an interactive storytelling system is described. The program code is executed by a processor. The non-transitory computer-readable medium includes program code to parse collected story narratives into a plurality of story narratives linked by story development questions. The non-transitory computer-readable medium also includes program code to present a selected story narrative, including a selected story development question regarding a prediction of a story development in the selected narrative. The non-transitory computer-readable medium further includes program code to determine a difference between the story development in the selected narrative and an answer received in response to the selected story development question. The non-transitory computer-readable medium also includes program code to select a next, selected story narrative of the story development based on the difference, including a next selected story development question regarding a next prediction of the story development in the next, selected narrative. The non-transitory computer-readable medium further includes program code to repeat the program code to present, the program code to determine, and the program code to select based on subsequent differences between the story development in subsequent narratives and subsequent answers received in response to subsequent questions.

A system for an interactive storytelling is described. The system includes a story narrative parsing module to parse collected story narratives into a plurality of story narratives linked by story development questions. The system also includes a story narrative presentation module to present a selected story narrative, including a selected story development question regarding a prediction of a story development in the selected narrative. The system further includes a difference detection module to determine a difference between the story development in the selected narrative and an answer received in response to the selected story development question. The system also includes a story narrative selection module to select a next, selected story narrative of the story development based on the difference, including a next selected story development question regarding a next prediction of the story development in the next, selected narrative. The system further includes a story narrative completion module to repeat the program code to present, the program code to determine, and the program code to select based on subsequent differences between the story development in subsequent narratives and subsequent answers received in response to subsequent questions.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of an interactive story telling system, in accordance with aspects of the present disclosure.

FIG. 2 is a block diagram illustrating an exemplary software architecture that may modularize artificial intelligence (AI) functions for an interactive storytelling system, according to aspects of the present disclosure.

FIG. 3 is a diagram illustrating a hardware implementation for an interactive story telling system, according to aspects of the present disclosure.

FIG. 4 is a graph illustrating gradual modifications of narrators of an interactive storytelling system, in accordance with aspects of the present disclosure.

FIG. 5 is a block diagram illustrating an interactive storytelling system, in accordance with various aspects of the present disclosure.

FIG. 6 is a process flow diagram illustrating a method for an interactive storytelling system, according to aspects of the present disclosure. [FIG. 6 will be completed after claim language approval.]

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

From behavioral science, it is recognized that people find it easier to relate to people that are more similar. In particular, many people experience difficulty relating to and communicating with people of different backgrounds, cultures, and personalities. The following examples are circumstances in which humans struggle to understand each other, such as: (1) cross-cultural interactions in diverse organizations; (2) interactions between people of different political beliefs, in which echo chambers and polarization have led people of different groups to believe they have nothing in common with people of other groups; and/or (3) interactions in which one person makes a decision having an impact on another person, but without a sufficient good understanding of the lived experience of the affected person and how the decision may affect the person. For example, Person A has difficulty understanding or relating to people from group B. People in group B may have a different background from Person A, such as being of a different age, a different gender, and/or a different educational background.

Consequently, other people's lives are often a mystery, or worse, assumed to be a certain negative, stereotyped, or dehumanized way that further distances the individual from other people. Individuals can certainly read, watch videos, documentaries, or hear stories about other people, but these may not always be engaging nor do people explicitly want to sit down and engage with these media. An engaging way to interact with other people's narratives in a way that helps individuals understand the situation of their lives and build empathy with people different from them, is desired.

Storytelling often is a passive activity where the listener just listens to the story. Various aspects of the present disclosure are directed to interactive storytelling, in which the storytelling is paused, and participants are asked to engage their perspective taking skills to predict what a character's next move or action will be. This interaction beneficially leverages people's sense of curiosity, because people would wonder what happens next (as well as whether their prediction was correct).

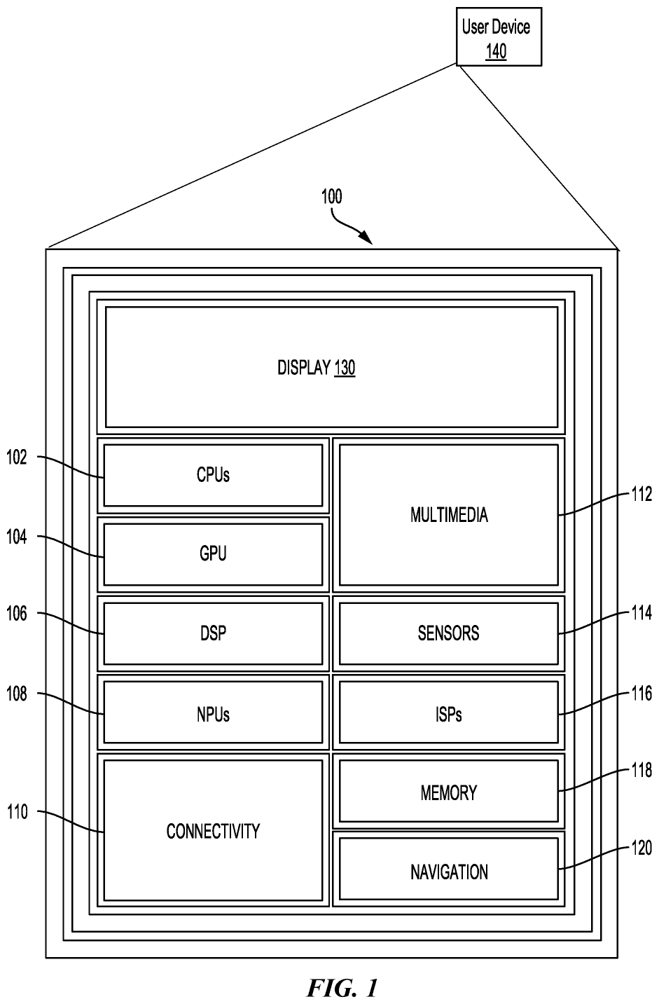

FIG. 1 illustrates an example implementation of the aforementioned system and method for an interactive storytelling system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include, sixth generation (6G) connectivity, fifth generation (5G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 may include code to provide an interactive storytelling system for guess-their-adventure to practice perspective taking. The instructions loaded into a processor (e.g., NPU 108) may also include code to parse collected story narratives into a plurality of story narratives linked by story development questions. The instructions loaded into the processor (e.g., NPU 108) may also include code to present a selected story narrative, including a selected question regarding a prediction of a story development in the selected narrative. The instructions loaded into the processor (e.g., NPU 108) may also include code to determine a difference between the story development in the selected narrative and an answer received in response to the selected question. The instructions loaded into the processor (e.g., NPU 108) may also include code to select a next, selected story narrative of the story development based on the difference, including a next, selected question regarding a next prediction of the story development in the next, selected narrative. The instructions loaded into the processor (e.g., NPU 108) may also include code to repeat the code to present, the code to determine, and the code to select based on subsequent differences between the story development in subsequent narratives and subsequent answers received in response to subsequent questions.

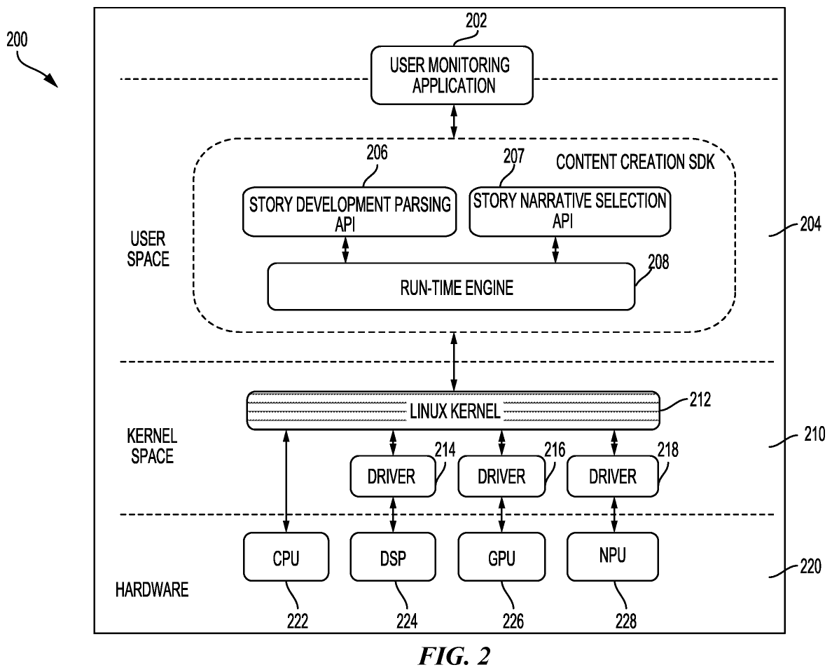

FIG. 2 is a block diagram illustrating a software architecture 200 that may modularize artificial intelligence (AI) functions for an interactive storytelling system, according to aspects of the present disclosure. Using the architecture, a user monitoring application 202 may be designed such that it may cause various processing blocks of an SOC 220 (for example a CPU 222, a DSP 224, a GPU 226, and/or an NPU 228) to perform supporting computations during run-time operation of the user monitoring application 202. FIG. 2 describes the software architecture 200 for an interactive storytelling system. It should be recognized that the interactive storytelling system is not limited to any specific information. According to aspects of the present disclosure, the user monitoring and the interactive storytelling functionality is applicable to any type of storytelling activity.

The user monitoring application 202 may be configured to call functions defined in a user space 204 that may, for example, provide interactive storytelling services. The user monitoring application 202 may make a request for compiled program code associated with a library defined in a story development parsing application programming interface (API) 206. The story development parsing API 206 is configured to parse collected story narratives into a plurality of story narratives linked by story development questions. Additionally, the story development parsing API 206 is configured to present a selected story narrative, including a selected question regarding a prediction of a story development in the selected narrative.

In response, compiled program code of a story narrative selection API 207 is configured to select a next, selected story narrative of the story development based on the difference, including a next, selected question regarding a next prediction of the story development in the next, selected narrative. Additionally, the story narrative selection API 207 is configured to repeat the story development parsing API 206 and the story narrative selection API 207 based on subsequent differences between the story development in subsequent narratives and subsequent answers received in response to subsequent questions. In some aspects of the present disclosure, the story narrative selection API 207 provides interactive storytelling, in which the storytelling is paused, and participants are asked to engage their perspective taking skills to predict what a character's next move or action will be. This interaction beneficially leverages people's sense of curiosity, because people would wonder what happens next (as well as whether their prediction was correct).

A run-time engine 208, which may be compiled code of a run-time framework, may be further accessible to the user monitoring application 202. The user monitoring application 202 may cause the run-time engine 208, for example, to take actions for selecting a different story narrative based on users' answers to a story development question. In response to selection story content, the run-time engine 208 may in turn send a signal to an operating system 210, such as a Linux Kernel 212, running on the SOC 220. FIG. 2 illustrates the Linux Kernel 212 as software architecture for the interactive storytelling system. It should be recognized, however, that aspects of the present disclosure are not limited to this exemplary software architecture. For example, other kernels may provide the software architecture to support the interactive storytelling functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

From behavioral science, it is recognized that people find it easier to relate to people that are more similar. In particular, many people experience difficulty relating to and communicating with people of different backgrounds, cultures, and personalities. Consequently, other people's lives are often a mystery, or worse, assumed to be a certain negative, stereotyped, or dehumanized way that further distances the individual from other people. Individuals can certainly read, watch videos, documentaries, or hear stories about other people, but these may not always be engaging nor do people explicitly want to sit down and engage with these media. An engaging way to interact with other people's narratives in a way that helps individuals understand the situation of their lives and build empathy with people different from them, is desired.

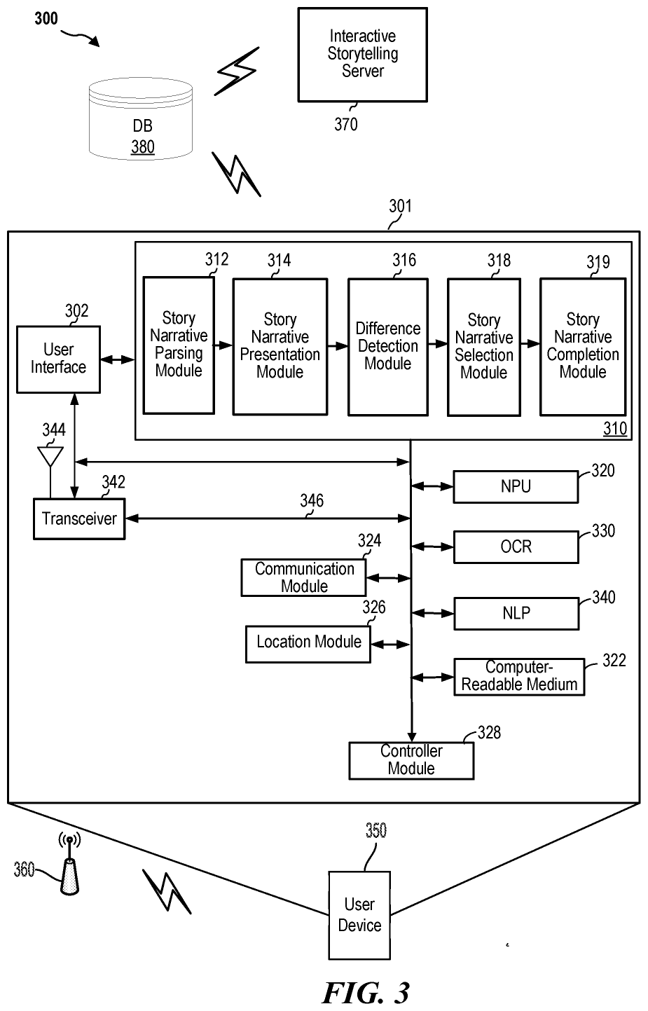

Storytelling often is a passive activity where the listener just listens to the story. Various aspects of the present disclosure are directed to interactive storytelling, in which the storytelling is paused, and participants are asked to engage their perspective taking skills to predict what a character's next move or action will be. This interaction beneficially leverages people's sense of curiosity, because people would wonder what happens next (as well as whether their prediction was correct). This interactive storytelling system provides an interface that enables users to actively participate in the story development, for example, as shown in FIG. 3.

FIG. 3 is a diagram illustrating a hardware implementation for an interactive storytelling system 300, according to aspects of the present disclosure. The interactive storytelling system 300 for guess-their-adventure to practice perspective taking. The interactive storytelling system 300 is configured to parse collected story narratives into a plurality of story narratives linked by story development questions. The interactive storytelling system 300 is also configured to present a selected story narrative, including a selected question regarding a prediction of a story development in the selected narrative. The interactive storytelling system 300 is configured to determine a difference between the story development in the selected narrative and an answer received in response to the selected question. In various aspects of the present disclosure, the interactive storytelling system 300 is configured to select a next, selected story narrative of the story development based on the difference, including a next, selected question regarding a next prediction of the story development in the next, selected narrative. Additionally, the interactive storytelling system 300 is configured to repeat the presentation, the determination, and the selection of a story narrative based on subsequent differences between the story development in subsequent narratives and subsequent answers received in response to subsequent questions.

The interactive storytelling system 300 includes a user monitoring system 301 and an interactive storytelling server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The interactive storytelling server 370 may parse collected story narratives into story narratives linked by story development questions. The interactive storytelling server 370 presents a selected story narrative, including a selected question regarding a prediction of a story development in the selected narrative. The interactive storytelling server 370 may also determine a difference between the story development in the selected narrative and an answer received in response to the selected story development question. The interactive storytelling server 370 may also select a next, selected story narrative of the story development based on determining the difference, including a next, selected question regarding a next prediction of the story development in the next, selected narrative. Additionally, the interactive storytelling server 370 may repeat the interactive storytelling process based on subsequent differences between the story development in subsequent narratives and subsequent answers received in response to subsequent questions.

The user monitoring system 301 may be implemented with an interconnected architecture, represented generally by an interconnect 346, which may be implemented as a controller area network (CAN). The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) module 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The user monitoring system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a neural network model for user monitoring and statistical data clarification functionality according to the present disclosure. The software, when executed by the NPU 320, the OCR 330 and the NLP 340, causes the user monitoring system 301 to perform the various functions described for presenting interactive storytelling content to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 and the NLP 340 to automatically detect multiple objects in a story curated by a user. The user monitoring system 301 may follow a process to detect and determine whether creative content is accessed by the user. When the user curates storytelling content, the user monitoring system 301 utilizes the OCR 330 and/or the NLP 340 to attach a representative text label to detected objects in the storytelling content curated by the user.

The user activity module 310 may be in communication with the user interface 302, the NPU 320, the computer-readable medium 322, the communication module 324, the location module 326, the controller module 328, the OCR 330, the NLP 340, and the transceiver 342. In one configuration, the user activity module 310 monitors communications from the user interface 302. The user interface 302 may monitor user communications to and from the communication module 324. According to aspects of the present disclosure, the OCR 330 and the NLP 340 automatically detect storytelling content curated by the user and may use computer vision techniques to automatically detect the objects in the image to enable text label attachment.

As shown in FIG. 3, the user activity module 310 includes a story narrative parsing module 312, a story narrative presentation module 314, a difference detection module 316, a story narrative selection module 318, and a story narrative completion module 319. The story narrative parsing module 312, the story narrative presentation module 314, the difference detection module 316, the story narrative selection module 318, and the story narrative completion module 319, may be components of a same or different artificial neural network, such as a deep convolutional neural network (CNN). The user activity module 310 is not limited to a CNN. The user activity module 310 monitors and analyzes answers to story development questions associated with a story narrative viewed by a user from the user interface 302.

This configuration of the user activity module 310 includes the story narrative parsing module 312 configured to parse collected story narratives into story narratives linked by story development questions. In some aspects of the present disclosure, the story narrative parsing module 312 uses the OCR 330 and the NLP 340 to parse the collected story narrative into story narratives linked by story development questions, which are answered by the user through the user interface 302. In some aspects of the present disclosure, the story narrative parsing module 312 analyzes the answers to the story development questions provided by the user through the user interface 302. In some aspects of the present disclosure, a crowdsource approach is used to gather narrative data (text, audio, video data) from narrators of different backgrounds for improving perspective taking by users.

In various aspects of the present disclosure, the user activity module 310 includes the story narrative presentation module 314 configured to present a selected story narrative, including a selected story development question regarding a prediction of a story development in the selected narrative. In some aspects of the present disclosure, the story narrative presentation module 314 generates questions based on the following actions or decision outcomes. For example, when telling a story about their car breaking down and needing to purchase a new one, the system can generate a story development question: “What kind of car did they purchase?” with multiple choice answers: an inexpensive used car, a hand-me-down from a relative, a new luxury car from a dealership, an expensive used car, or no car at all. Additionally, these answers may be mined from other people's narratives.

In this example, the user activity module 310 also includes a difference detection module 316 configured to determine a difference between the story development in the selected narrative and an answer received in response to the selected story development question. For example, a significant difference between the user's answer to the selected story development question and the story development in the selected narrative may indicate the story development is from a person that is significantly different from the user. As a result, listening to the person's story provides an engaging way to interact with other people's narratives in a way that helps individuals understand the situation of their lives and build empathy with people different from the user.

Additionally, the user activity module 310 includes the story narrative selection module 318 that is configured to select a next, selected story narrative of the story development based on determining the difference, including a next, selected question regarding a next prediction of the story development in the next, selected narrative. In some aspects of the present disclosure, the story narrative selection module 318 may select stories based on the similarities or differences between the user and the narrator. For example, it might be difficult to take the perspective of someone very different from you, so based on the demographics, the system may select someone somewhat similar to you to start out. As users progress in their perspective taking skills, the system may select narrators that are much different from them in terms of demographics and decisions. The scoring can take into account how different the narrators are from the listener and award more points for correct answers the more dissimilar a narrator is from the users.

As shown in FIG. 3, the user activity module 310 further includes the story narrative completion module 319 configured to repeat the interactive storytelling process based on subsequent differences between the story development in subsequent narratives and subsequent answers received from the user in response to subsequent questions. In some aspects of the present disclosure, the story narrative completion module 319 controls playback of portions of the narrative, pauses the narrative, and asks the listener what would happen next. The storytelling can continue until the end of the narrative in one session. By contrast, the storytelling can unfold in short snippets over multiple days. For example, it can be a fun two-minute task every day to listen to part of the study and guess the person's decisions to learn more about their life. That way, the perspective taking skill can be practiced as a habit. The interactive storytelling system 300 may also ask people what they themselves would do, and then ask what the narrator would do, to further emphasize the differences or shared traits with the narrator. In various aspects of the present disclosure, the interactive storytelling system 300 may keep score of how often the user got the correct answer to show how well the person is improving their perspective taking skills.

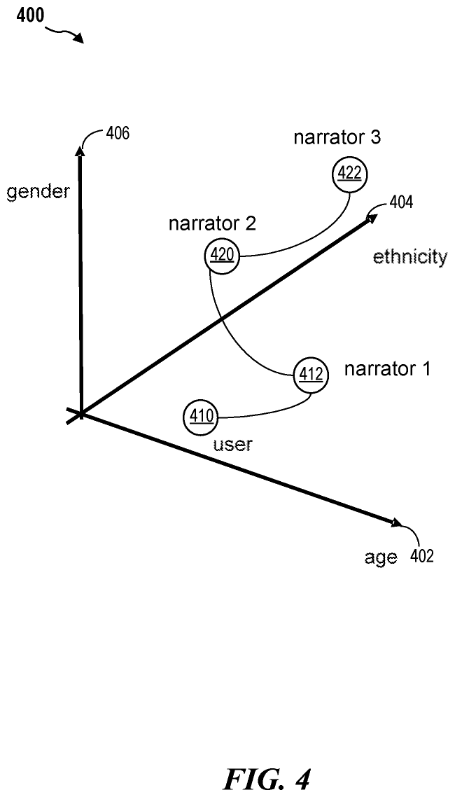

In some aspects of the present disclosure, the user activity module 310 may be implemented and/or work in conjunction with the interactive storytelling server 370. In one configuration, a database (DB) 380 stores data related to narrative data (text, audio, video data) from narrators of different backgrounds, which may be displayed as output through the user interface 302. In some aspects of the present disclosure, the interactive storytelling system 300 may be implemented as a web browser plugin. In other aspects of the present disclosure, the interactive storytelling server 370 provides an offline application that collects narrative data through the user interface 302. In other aspects of the present disclosure, the interactive storytelling system 300 may be implemented as a mobile application that augments the interactive storytelling process by adapting story narrative display through the user interface 302, for example, as shown in FIG. 4.

FIG. 4 is a graph 400 illustrating gradual modifications of narrators of an interactive storytelling system, in accordance with aspects of the present disclosure. Some aspects of the present disclosure allow a user 410 (e.g., a human user) to interact with narrative stories from another person, referred to as a narrator. As shown in the graph 400 of FIG. 4, a first narrator 412 exhibits a slightly different background from the user 410, and a second narrator 420 exhibits a further different background from the user, and a third narrator 422 exhibits an opposite background from the user 410. For example, the different backgrounds may include different ages, races, gender, incomes, education levels, etc. In this example, the graph 400 is a three-dimensional (3D) graph including age as an X-axis 402, ethnicity as a Y-axis 404, and gender as a Z-axis 406.

Behavioral science recognizes that people find it easier relating to people that are more similar to themselves. Some aspects of the present disclosure begin by presenting a story from a first narrator 412 that is similar to the user 410, by having a small psychological distance from the user 410. For example, as shown in FIG. 4, the first narrator 412 shares similar characteristics with the user 410, but with a different ethnicity. Then, the user 410 would view the story narrative from the first narrator 412 to practice perspective taking in order to building a common understanding of a perspective of the first narrator 412. Next, the system may select a story narrative from a second narrator 420 having a different gender and ethnicity to provide a further, psychological distance from the user 410.

Progressively, these aspects of the present disclosure select story narratives from narrators that slowly increase the psychological distance in the direction of a third narrator 422, until the user 410 feels that they have some understanding of the perspective of people similar to the third narrator 422. As shown in FIG. 4, the interactive storytelling presents narrative stories to the user 410 from the first narrator 412, the second narrator 420, and the third narrator 422 that are increasingly more different from the user 410. Although the graph 400 of FIG. 4 illustrates the first narrator 412, the second narrator 420, and the third narrator 422, aspects of the present disclosure contemplate an increased number of narrators depending on a degree of differences between the user 410 and a target narrator.

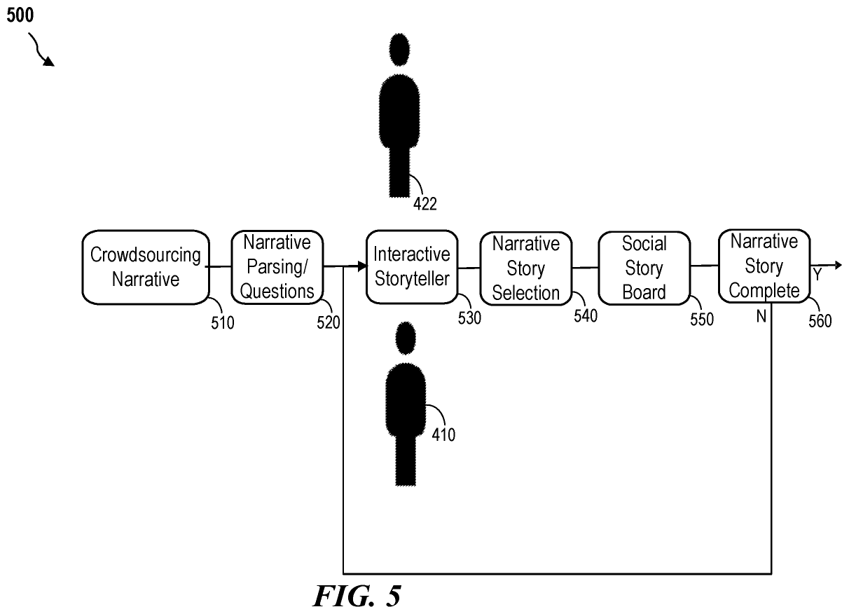

FIG. 5 is a block diagram illustrating an interaction method of an interactive storytelling system, in accordance with aspects of the present disclosure. A method 500 begins at block 510, in which the interactive storytelling system performs a crowdsource approach to gather narrative data (text, audio, video data) from narrators of different backgrounds. The narrators can tell a story of a typical or unusual day, the story of how they grew up, a series of consequential choices they had to make in their lives, etc. The interactive storytelling system would also collect demographics of the narrators.

At block 520, the interactive storytelling system would parse the narratives to identify where actions were taken, or decisions were made. The interactive storytelling system would then generate questions based on the following actions or decision outcomes. For example, when telling a story about their car breaking down and needing to purchase a new one, the system can generate a question “What kind of car did they purchase?” with multiple choice answers: an inexpensive used car, a hand-me-down from a relative, a new luxury car from a dealership, an expensive used car, or no car at all. These answers may be mined from other people's narratives. The generation of questions would take into account the demographics of the narrator so that the listener can answer the questions in the context of the narrator's background.

At block 530, the interactive storytelling system would play back part of the narrative, pause the narrative, and ask the user 410 what would happen next. The storytelling can continue until the end of the narrative in one session. Alternatively, the storytelling can unfold in short snippets over multiple days. For example, it can be a fun two-minute task every day to listen to part of the study and guess the person's decisions to learn more about their life. That way, the perspective taking skill can be practiced as a habit. The interactive storytelling system may also ask people what they themselves would do, and then ask what the third narrator 422 would do, to further emphasize the differences or shared traits with the third narrator 422. The interactive storytelling system may keep score of how often the user got the correct answer to show how well the user 410 is improving their perspective taking skills.

At block 540, the interactive storytelling system may select stories based on the similarities or differences between the user 410 and the third narrator 422. For example, it might be difficult to take the perspective of the third narrator 422 because the third narrator 422 is very different from the user 410. Consequently, based on the demographics, the interactive storytelling system may select the first narrator 412, which is somewhat similar to the user 410 to start out. As the user 410 progresses in their perspective taking skills, the interactive storytelling system may select narrators that are much different from them in terms of demographics and decisions from the user 410, such as the third narrator 422.

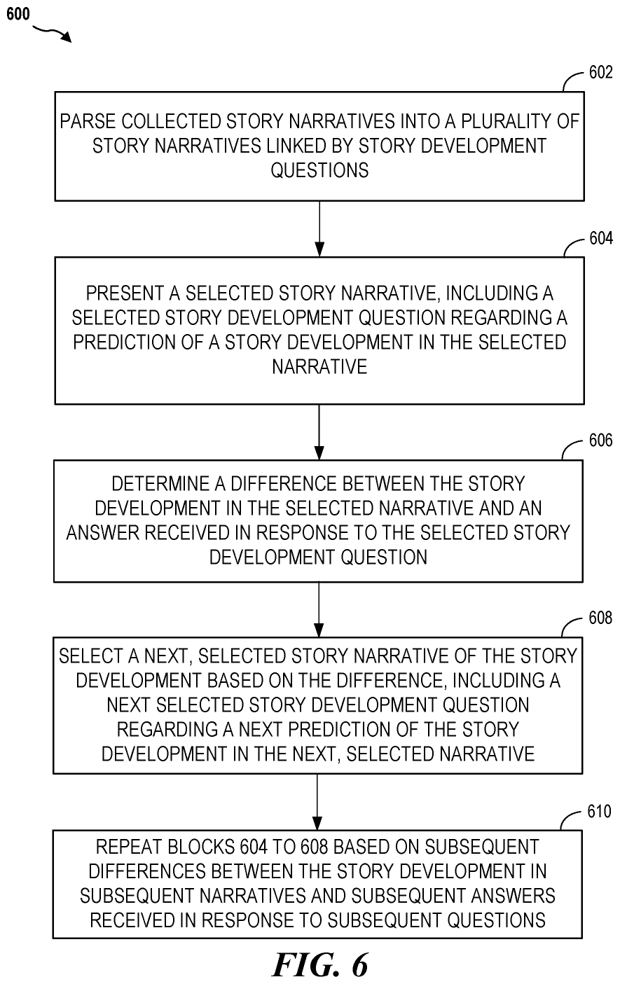

At optional block 550, the interactive storytelling system may repurpose narratives as text prompts sent to image generation tools (e.g., Dall-E 2, Stable Diffusion, etc.) to automatically generate storyboards. Storyboards can take a variety of forms, but most commonly are a set of 3-5 panels showing a scenario in a comic-book style arrangement of 2D images and short phrases. The image generation tool can be tuned to generate images in a particular format (e.g., one that appears more hand-drawn). Text from the narrative can accompany each panel (or in some cases be injected into the panel in speech bubbles). End users can use the same image generation tools to create a final panel or set of panels to complete a narrative. User interface components can be added to allow people to vote on the most empathetic “conclusions” to the initial storyboard panels, thereby filtering out less popular panels. At block 560, the interactive storytelling process is repeated until the narrative story is complete. An interactive storytelling system may engage in a process, for example, as shown in FIG. 6.

FIG. 6 is a process flow diagram illustrating a method 600 for an interactive storytelling system, according to aspects of the present disclosure. The method 600 begins at block 602, in which collected story narratives are parsed into a plurality of story narratives linked by story development questions. For example, as shown in FIG. 3, this configuration of the user activity module 310 includes the story narrative parsing module 312 configured to parse collected story narratives into story narratives linked by story development questions. In some aspects of the present disclosure, the story narrative parsing module 312 uses the OCR 330 and the NLP 340 to parse the collected story narrative into story narratives linked by story development questions, which are answered by the user through the user interface 302. In some aspects of the present disclosure, the story narrative parsing module 312 analyzes the answers to the story development questions provided by the user through the user interface 302. In some aspects of the present disclosure, a crowdsource approach is used to gather narrative data (text, audio, video data) from narrators of different backgrounds for improving perspective taking by users.

At block 604. a selected story narrative is presented, including a selected story development question regarding a prediction of a story development in the selected narrative. For example, as shown in FIG. 3, the user activity module 310 includes the story narrative presentation module 314 configured to present a selected story narrative, including a selected story development question regarding a prediction of a story development in the selected narrative. In some aspects of the present disclosure, the story narrative presentation module 314 generates questions based on the following actions or decision outcomes. For example, when telling a story about their car breaking down and needing to purchase a new one, the system can generate a story development question: “What kind of car did they purchase?” with multiple choice answers: an inexpensive used car, a hand-me-down from a relative, a new luxury car from a dealership, an expensive used car, or no car at all. Additionally, these answers may be mined from other people's narratives.

At block 606, a difference is determined between the story development in the selected narrative and an answer received in response to the selected story development question. For example, as shown in FIG. 3, the user activity module 310 also includes a difference detection module 316 configured to determine a difference between the story development in the selected narrative and an answer received in response to the selected story development question. For example, a significant difference between the user's answer to the selected story development question and the story development in the selected narrative may indicate the story development is from a person that is significantly different from the user. As a result, listening to the person's story provides an engaging way to interact with other people's narratives in a way that helps individuals understand the situation of their lives and build empathy with people different from the user.

At block 608, a next, selected story narrative of the story development is selected based on the difference, including a next selected story development question regarding a next prediction of the story development in the next, selected narrative. For example, as shown in FIG. 3, the user activity module 310 includes the story narrative selection module 318 that is configured to select a next, selected story narrative of the story development based on determining the difference, including a next, selected question regarding a next prediction of the story development in the next, selected narrative. In some aspects of the present disclosure, the story narrative selection module 318 may select stories based on the similarities or differences between the user and the narrator. For example, it might be difficult to take the perspective of someone very different from you, so based on the demographics, the system may select someone somewhat similar to you to start out. As users progress in their perspective taking skills, the system may select narrators that are much different from them in terms of demographics and decisions. The scoring can take into account how different the narrators are from the listener and award more points for correct answers the more dissimilar a narrator is from the users.

At block 610, blocks 604 to 608 are repeated based on subsequent differences between the story development in subsequent narratives and subsequent answers received in response to subsequent questions. For example, as shown in FIG. 3, the user activity module 310 further includes the story narrative completion module 319 configured to repeat the interactive storytelling process based on subsequent differences between the story development in subsequent narratives and subsequent answers received from the user in response to subsequent questions. In some aspects of the present disclosure, the story narrative completion module 319 controls playback of portions of the narrative, pauses the narrative, and asks the listener what would happen next. The storytelling can continue until the end of the narrative in one session. By contrast, the storytelling can unfold in short snippets over multiple days. For example, it can be a fun two-minute task every day to listen to part of the study and guess the person's decisions to learn more about their life. That way, the perspective taking skill can be practiced as a habit. The interactive storytelling system 300 may also ask people what they themselves would do, and then ask what the narrator would do, to further emphasize the differences or shared traits with the narrator. In various aspects of the present disclosure, the interactive storytelling system 300 may keep score of how often the user got the correct answer to show how well the person is improving their perspective taking skills.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for an interactive storytelling system, the method comprising:
parsing collected story narratives into a plurality of story narratives linked by story development questions;
presenting a selected story narrative, including a selected story development question regarding a prediction of a story development in the selected narrative;
determining a difference between the story development in the selected narrative and an answer received in response to the selected story development question;
selecting a next, selected story narrative of the story development based on the difference, including a next selected story development question regarding a next prediction of the story development in the next, selected narrative; and
repeating the presenting, the determining, and the selecting based on subsequent differences between the story development in subsequent narratives and subsequent answers received in response to subsequent questions.

2. The method of claim 1, in which parsing the collected story narratives comprises automatically parsing the collected story narratives using an optical character recognition (OCR) module and/or a natural language processor (NLP).

3. The method of claim 2, in which the parsing collected story narratives comprises automatically linking the plurality of story narrative using the optical character recognition (OCR) module and/or the natural language processor (NLP) to attach the story development question.

4. The method of claim 1, in which presenting comprising:
displaying, through a user interface, selected story narrative; and
displaying the selected story development question regarding a prediction of a story development in the selected narrative.

5. The method of claim 1, in which determining the difference comprises determining a psychological distance between a user and a narrator of the selected story narrative based on the answer received in response to the selected story development question.

6. The method of claim 5, in which selecting the next, selected story narrative of the story development comprises:
analyzing the answer received in response to the selected question and the psychological distance;
identifying the next, selected story narrative based on the analyzing; and
displaying the next, selected story narrative, including the next, selected question regarding a next prediction of the story development in the next, selected narrative.

7. The method of claim 1, in which repeating comprises displaying, through a user interface, selected narratives and the story development in selected story narrative until the story development is complete.

8. The method of claim 1, further comprising selecting a narrator of the selected story narrative according to a gradually increased psychological distance between a user and the selected narrator.

9. A non-transitory computer-readable medium having program code recorded thereon for an interactive storytelling system, the program code being executed by a processor and comprising:
program code to parse collected story narratives into a plurality of story narratives linked by story development questions;
program code to present a selected story narrative, including a selected story development question regarding a prediction of a story development in the selected narrative;
program code to determine a difference between the story development in the selected narrative and an answer received in response to the selected story development question;
program code to select a next, selected story narrative of the story development based on the difference, including a next selected story development question regarding a next prediction of the story development in the next, selected narrative; and
program code to repeat the program code to present, the program code to determine, and the program code to select based on subsequent differences between the story development in subsequent narratives and subsequent answers received in response to subsequent questions.

10. The non-transitory computer-readable medium of claim 9, in which the program code to parse the collected story narratives comprises program code to automatically parse the collected story narratives using an optical character recognition (OCR) module and/or a natural language processor.

11. The non-transitory computer-readable medium of claim 10, in which the program code to parse the collected story narratives comprises program code to automatically link the plurality of story narrative using the optical character recognition (OCR) module and/or the natural language processor (NLP) to attach the story development question.

12. The non-transitory computer-readable medium of claim 9, in which the program code to present comprising:
program code to display, through a user interface, selected story narrative; and
program code to display the selected story development question regarding a prediction of a story development in the selected narrative.

13. The non-transitory computer-readable medium of claim 9, in which the program code to determine the difference comprises program code to determine a psychological distance between a user and a narrator of the selected story narrative based on the answer received in response to the selected story development question.

14. The non-transitory computer-readable medium of claim 13, in which the program code to select the next, selected story narrative of the story development comprises:
program code to analyze the answer received in response to the selected question and the psychological distance;
program code to identify the next, selected story narrative based on the analyzing; and
program code to display the next, selected story narrative, including the next, selected question regarding a next prediction of the story development in the next, selected narrative.

15. The non-transitory computer-readable medium of claim 9, in which the program code to repeat comprises program code to display, through a user interface, selected narratives and the story development in selected story narrative until the story development is complete.

16. The non-transitory computer-readable medium of claim 9, further comprising program code to select a narrator of the selected story narrative according to a gradually increased psychological distance between a user and the selected narrator.

17. A system for an interactive storytelling, the system comprising:
a story narrative parsing module to parse collected story narratives into a plurality of story narratives linked by story development questions;
a story narrative presentation module to present a selected story narrative, including a selected story development question regarding a prediction of a story development in the selected narrative;
a difference detection module to determine a difference between the story development in the selected narrative and an answer received in response to the selected story development question;
a story narrative selection module to select a next, selected story narrative of the story development based on the difference, including a next selected story development question regarding a next prediction of the story development in the next, selected narrative; and
a story narrative completion module to repeat the program code to present, the program code to determine, and the program code to select based on subsequent differences between the story development in subsequent narratives and subsequent answers received in response to subsequent questions.

18. The system of claim 17, in which the story narrative parsing module comprises an optical character recognition (OCR) module and/or a natural language processor to automatically parse the collected story narratives.

19. The system of claim 17, in which the in which the story narrative parsing module comprises an optical character recognition (OCR) module and/or a natural language processor to automatically link the plurality of story narrative to attach the story development question.

20. The system of claim 17, in which the difference detection module is further to determine a psychological distance between a user and a narrator of the selected story narrative based on the answer received in response to the selected story development question.
